(19) United States
(12) Patent Application Publication
(10) Pub. No.: US 2020/0091861 A1
(43) Pub. Date: Mar. 19, 2020

(54) Portable Solar Collector

(71) Applicants: William N. TALLY, Milford, MI (US); Michael Andrew KOVALCIK, Farmington Hills, MI (US); Renew Health Limited, Farmington Hills, MI (US)

(72) Inventors: William Tally, Milford, MI (US); Michael Kovalcik, Farmington Hills, MI (US)

(73) Assignee: Renew Health Ltd, Farmington Hills, MI (US)

(21) Appl. No.: 16/494,453

(22) PCT Filed: Mar. 16, 2018
(86) PCT No.: PCT/US2018/022839

§ 371 Date: Sep. 16, 2019

Related U.S. Application Data
(60) Provisional application No. 62/472,928, filed on Mar. 17, 2017.
(60) Provisional application No. 62/479,707, filed on Mar. 31, 2017.

(51) Int. Cl. H02S 30/20; H02S 10/40; H02S 20/30

(52) U.S. Cl. CPC H02S 30/20; H02S 20/30; H02S 10/40

(57) ABSTRACT

The disclosure relates to portable collector with solar panels where the collector may be reversibly rearranged to expose the solar panels to light.

### BACKGROUND

In many situations, access to a power grid may not be possible. For example, a power grid may not be available in remote or isolated areas. In addition, there may be situations where access to a power grid is not desirable. For example, many individuals participate in recreational activities such as camping in isolated, unspoiled areas. However, a source of power may be desirable or required in these and other situations. For example, during camping, it may be necessary to recharge batteries that may be used to power lights or other gear. A source of power may be required in emergency situations in isolated areas. Further, it a renewable source of energy to power may be preferred to generators or similar devices, which consume fuel.

For example, electrical power derived from solar power is becoming increasingly popular. Large-scale solar power installations are well-known. However, there is an increasing demand for portable sources of renewable energy, including solar power. Consequently, there is a need for a portable source of solar power. The present disclosure describes examples of an efficient portable solar collector.

### SUMMARY

The present disclosure relates to portable solar collectors where a solar collector includes at least one solar panel, a case, at least one support structure and at least one port.

### BRIEF DESCRIPTION OF DRAWINGS

FIG. 1 shows a perspective view of one example of a collector when the collector is completely folded

FIG. 2 shows one example of a collector when viewed towards one side when the collector is completely unfolded.

FIG. 3 shows an example of a collector when viewed from the backside of the collector when the collector is unfolded.

FIG. 4 shows a perspective view from one side of an example of a collector when the collector is unfolded

FIG. 5 shows a perspective view from the back of an example of a collector when the collector is completely unfolded

FIG. 6 shows a perspective view from one side of an example of a collector when the collector is partially folded.

FIG. 7 shows a view of a solar collector of the disclosure viewed from the side when folded

FIG. 8 shows a view of a solar collector of the disclosure viewed from another side when folded

FIG. 9 shows a view of a solar collector of the disclosure viewed from the side with support structure positioned.

FIG. 10 shows a view of a solar collector of the disclosure viewed from the side with support structure positioned.

FIG. 11 shows a view of a perspective view solar collector of the disclosure viewed from the back when unfolded.

### DETAILED DESCRIPTION

It is to be understood that the disclosed examples that follow are merely exemplary and specific details disclosed herein are not to be interpreted as limiting, but merely as a basis for the claims and as a representative basis for teaching one skilled in the art. The systems and methods described herein are not limited in their application to the details of construction and the arrangement of components set forth in the description or illustrated in the drawings. Also, the phraseology and terminology used herein is for the purpose of description and should not be regarded as limiting. The use of “including”, “comprising”, “having”, “containing”, “involving” and variations thereof herein, is meant to encompass the items listed thereafter, equivalents thereof, and additional items, as well as alternate examples consisting of the items listed thereafter exclusively

It is to be understood that the disclosed examples that follow are merely exemplary and specific details disclosed herein are not to be interpreted as limiting, but merely as a basis for the claims and as a representative basis for teaching one skilled in the art. The systems and methods described herein are not limited in their application to the details of construction and the arrangement of components set forth in the description or illustrated in the drawings. Also, the phraseology and terminology used herein is for the purpose of description and should not be regarded as limiting. The use of “including”, “comprising”, “having”, “containing”, “involving” and variations thereof herein, is meant to encompass the items listed thereafter, equivalents thereof, and additional items, as well as alternate examples consisting of the items listed thereafter exclusively.

The present disclosure relates to a portable solar collector. According to the disclosure, the collector includes at least one solar panel. A collector, according to the disclosure, allows the deployment, display, exposure or positioning of the at least one solar panel such that light impinges on the solar panel(s) to produce electrical energy. The collector may be linked to one or more devices that utilize the energy. According to the disclosure, a collector may have a mode or position where it may be collapsed, rearranged or folded such that the solar panels are not exposed or displayed but are protected by the case. The case may be easily transported to a new location. In preferred examples, the case may then be unfolded or rearranged such that the at least one solar panel may be deployed, exposed or displayed at the new location.

The energy collected by the solar panels may be transferred to devices such that the device may be powered or charged by the energy. For example, and without limitation, handheld mobile devices, battery or power packs, lights or lighting systems or portable medical devices may be linked to a portable solar collector disclosed here. In preferred examples, the solar panel case is linked electrically to a portable power pack, which includes rechargeable battery cells. In preferred examples, the solar panels provide direct current (DC) to devices that utilize DC.

Portable solar collectors of the disclosure are compact when the solar panels are not in the deployed state. That is, the collector may be carried or transported by one individual in a manner similar to a piece of luggage. Collectors of the disclosure may be transported, by example, only and without limitation, by hand, by bicycles, motorcycles, or by cars. In preferred examples, the collector is from about 4 pounds to about 20 pounds in weight. In preferred examples, the collector is from about 4 pounds to about 15 pounds or from about from 4 pounds to about 12 pounds. In preferred examples, the collector is about 5 to about 6 pounds. In additional preferred examples, the collector weighs from about 10.5 pounds to about 12 pounds.

In preferred examples, the collector in the folded state is from about 9 to about 30 inches in length, about 9 inches to about 30 inches in tall and about 1 to 4 inches in width. In preferred examples, the collector is approximately 14 inches in length by 14 inches tall by 1.5 inches in width when in the completely folded state. In additional preferred examples, the collector is approximately 20 inches in length by 17 inches tall by 2.5 inches in width when in the completely folded state. In the completely unfolded state, the collector is from about 30 to about 65 inches in length. In some preferred examples, the collector is about 42 inches to about 43 inches in length when unfolded. In some preferred examples, the collector is about 58 inches to about 59 inches in length when unfolded.

According to the disclosure, a collector includes a case, at least one solar panel, at least one support structure and at least one connection port.

A collector of the disclosure includes a case. The case holds the at least one solar panel and allows the at least one solar panel to be deployed, displayed or positioned to allow the impingement and collection of light by the at least one solar panel. According to the disclosure, the case may collapse, rearrange or fold such that the at least one solar panel is covered or maintained in a position that allows the solar collector to be easily carried. In the collapsed position, the case protects the solar panels when, for example and without limitation, the panels are not in use and the collector is being transported. In preferred examples, the case is approximately briefcase-shaped. The case may include one or more handles to allow users to carry the collector. The case may be composed of a durable or heat-resistant material. In preferred examples, the case is made of acrylonitrile styrene acrylate (ABS).

According to the disclosure, a case may include at least one solar panel. A case of the disclosure may have one solar panel, may have two solar panels may have three solar panels or may have four solar panels. In further examples, the case may include more than four solar panels. In particularly preferred examples, the case includes three solar panels.

Solar panels may assume numerous shapes. In preferred examples, the at least one solar panel is rectangular or square. In preferred examples, the at least one solar panel is from about 250 mm to about 400 mm one dimension. In preferred examples, the at least one solar panel is from about 250 mm to about 600 mm in a second dimension. In preferred examples, the dimensions of the at least one solar panel is from about 280 mm by about 320 mm. In additional preferred examples, the dimensions of the at least one solar panel is from about 350 mm by about 450 mm. In preferred examples, the solar panels are made of monocrystalline silicon. In preferred examples, each solar panel may be composed of one or more solar cells.

The solar panels of the detector may be connected in series or parallel or some combination of in series or in parallel. In preferred embodiments, the solar panels are connected in parallel.

According to the disclosure, the total rating of the solar panels may be from about 10 W to about 80 W. In preferred examples, the rating may be from about 20 to about 50 W. In particularly preferred examples, the rating is about 25 to about 35 W. In preferred examples, the rating of each solar panel is equal to the rating of each of the other solar panels. In other examples, the rating of each of solar panels may be different. In other preferred examples, the rating is from about 55 W to about 65 W. In preferred examples, a collector has three solar panels of equal size with a rating of 10 W for each solar panel. In other preferred examples, the collector has three solar panels of equal size with rating of 20 W for each solar panel.

In preferred examples, the case includes one or more support structures, which may be used to position or support the solar panels at a good angle for the impingement of light on the solar panels or the collection of light by the solar panel. The angle may be determined based on latitude of a location, time of year, time of day. In preferred examples, the support structure may be integrated into the solar panel case. The one or more support structures may be collapsed or folded into the solar panel case when not in use. When the solar panels are to be deployed, the one or more support structures may be moved from folded position to a deployed position where the one or more support structures may position the deployed solar panels at a predetermined angle. The one or more support structures may be attached to the body of the case with hinges where the hinges allow the at least one support structure to be moved from a folded position to a deployed position.

According to the disclosure, the collector includes at least one port. The at least one port connects the collector with a load. In preferred examples, the collector includes one port for each panel of the collector.

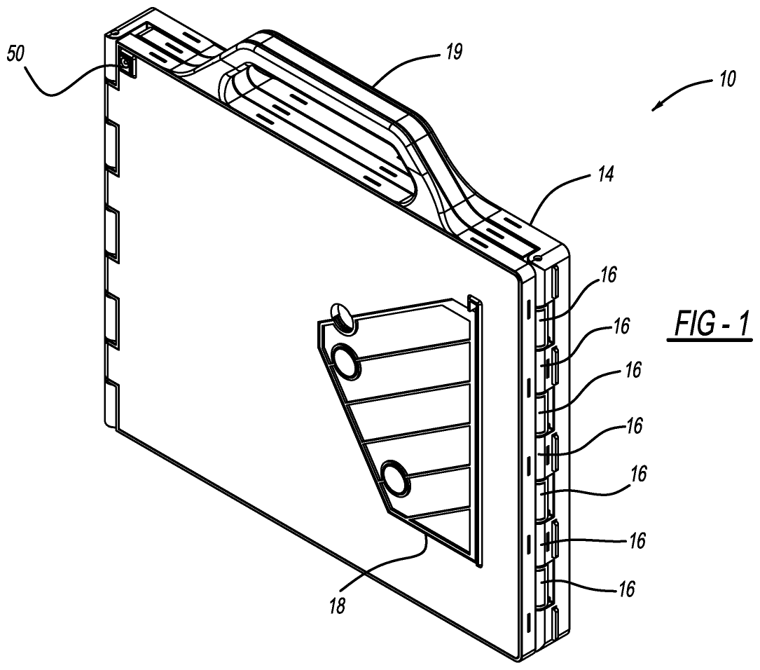

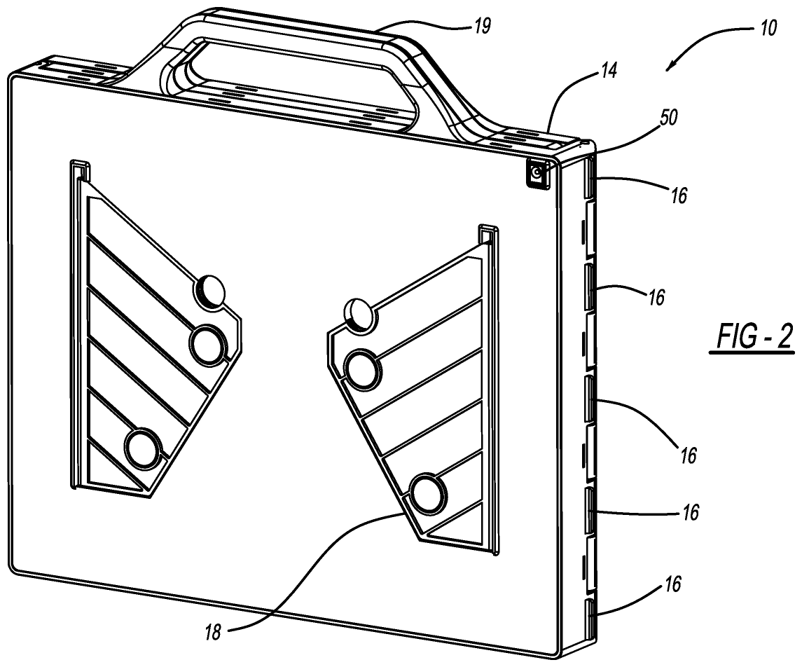

FIG. 1 shows one example of a collector 10 according to the disclosure in a completely folded state. The collector includes case 14 with hinges 16 and handles 19. Connection port 50 is shown. One folded support structure 18 is shown in this figure. FIG. 2 shows the example of FIG. 1 as seen from the side. The collector includes case 14 with hinges 16 and handles 19. Connection port 50 is shown.

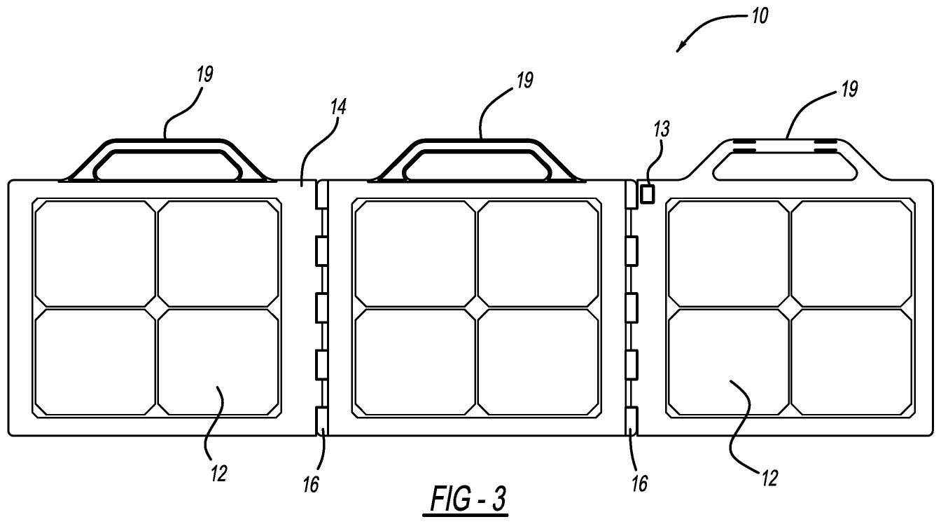

FIG. 3 shows a perspective view of an unfolded collector 10 according to the disclosure. Collector 10 has case 14 with hinges 16 and handles 19 with three solar panels 12 exposed. Multiple support structures 18 are shown in this view. In addition, this view shows protuberance 13.

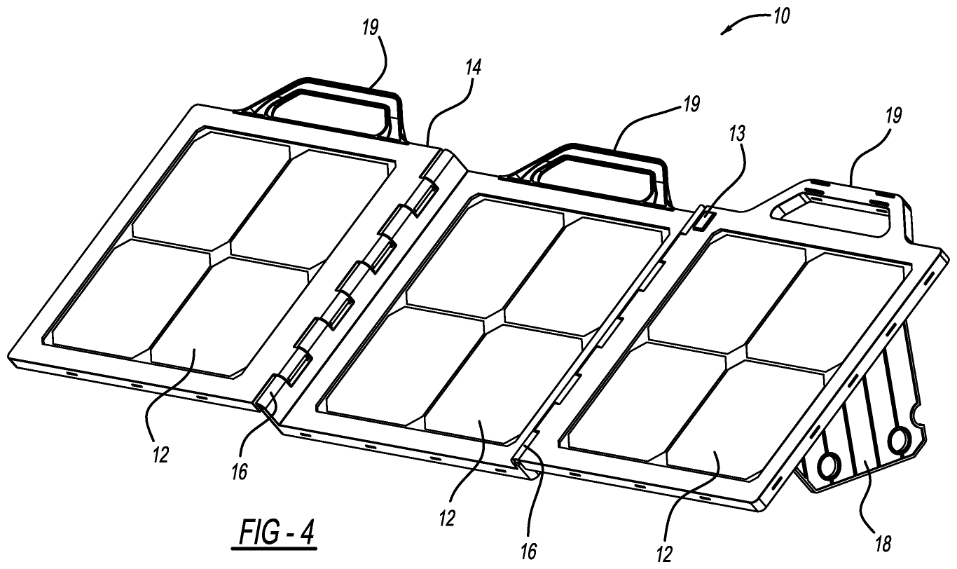

FIG. 4 shows a perspective view of side of a collector 10 when the collector is unfolded. The collector 10 includes case 14 with handle 19, hinges 16 and support structure 18. Port 50 is also shown. Three solar panels 50 are shown.

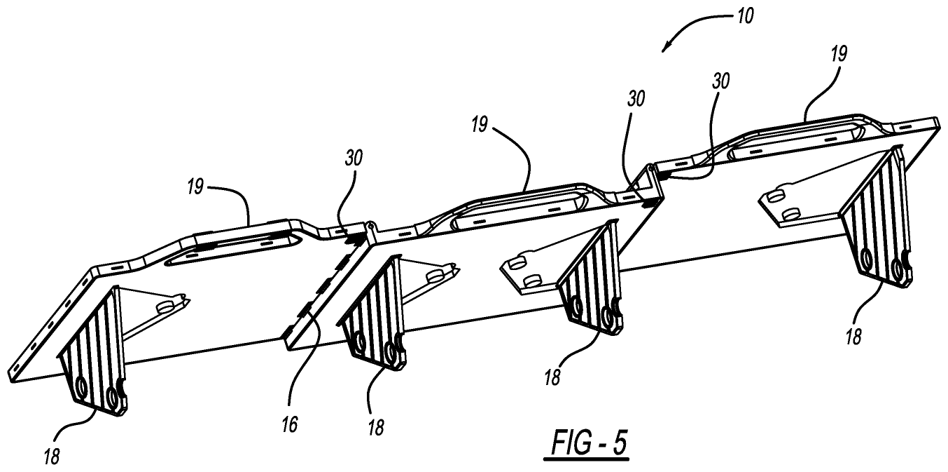

FIG. 5 shows another perspective view of side of a collector when the collector is as seen from the back. The collector 10 includes case 14 with handle 19, hinges 16 and support structures 18. Ports 30 is also shown.

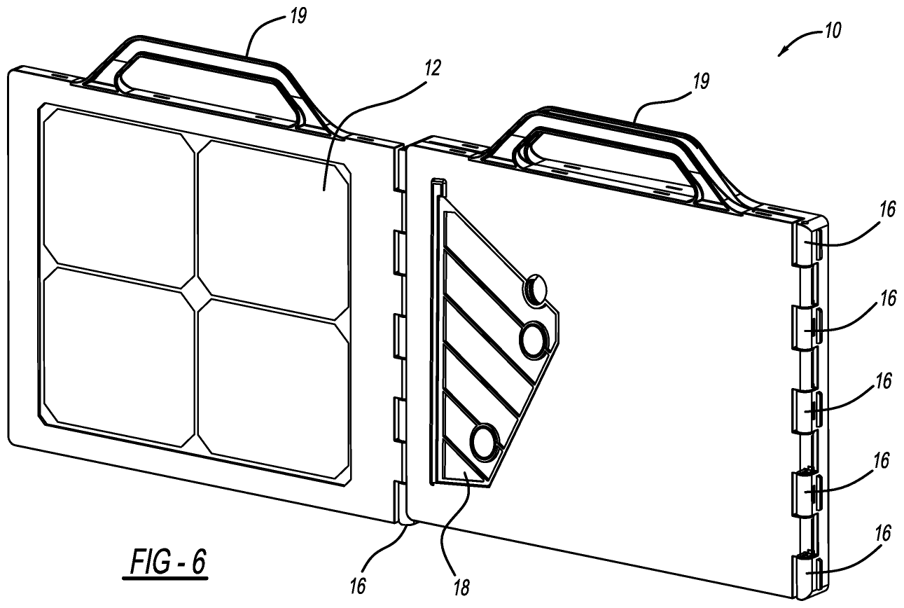

FIG. 6 shows a view of a collector 10 where the collector is partially folded showing only one solar panel 12. This view shows case 14 with hinges 16 and handles 19 and collapsed support structure 18.

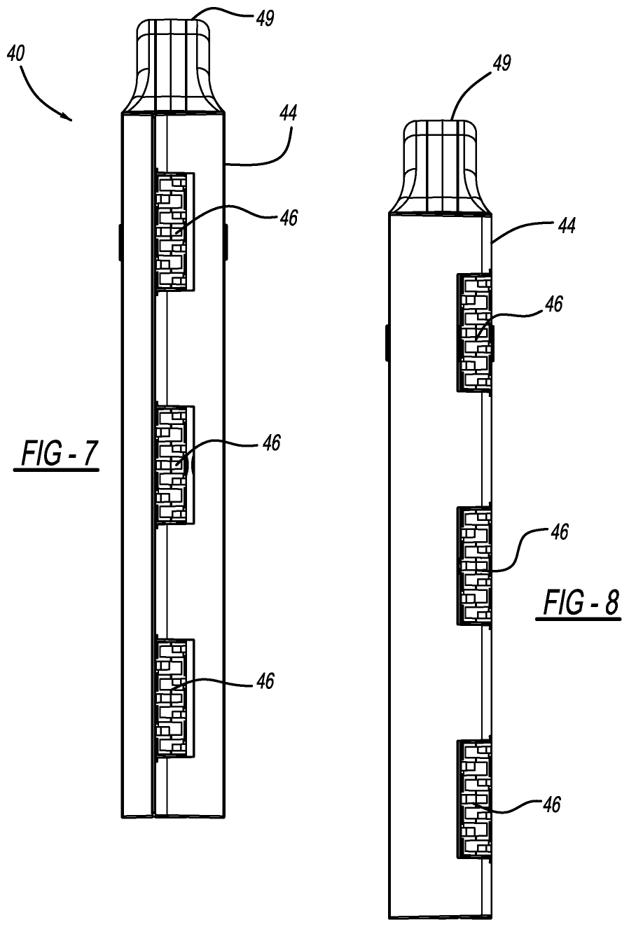

FIGS. 7-11 show views of a solar collector according to the disclosure. In this example, a spring is used to position the support structures firmly. FIGS. 7 and 8 shows a view of a folded solar collector as seen from the side. The collector 40 includes case 44 with hinges 46 and handles 49. FIG. 8 shows a similar view as viewed from the other side.

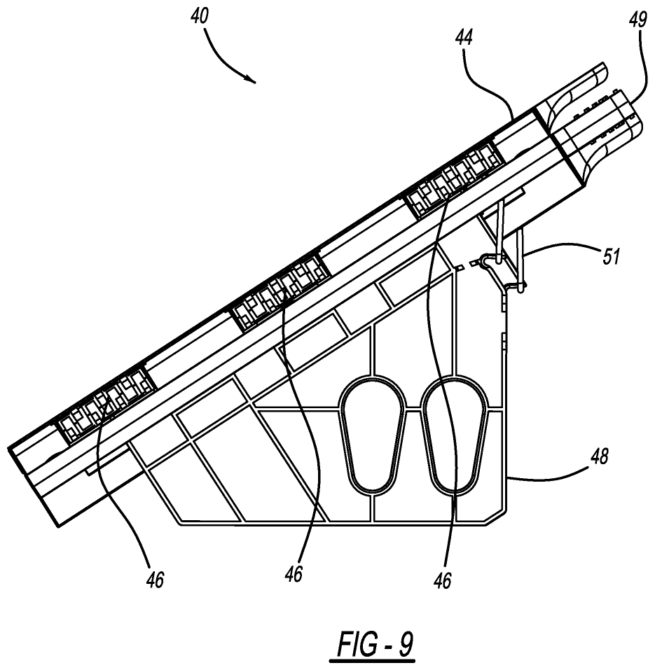

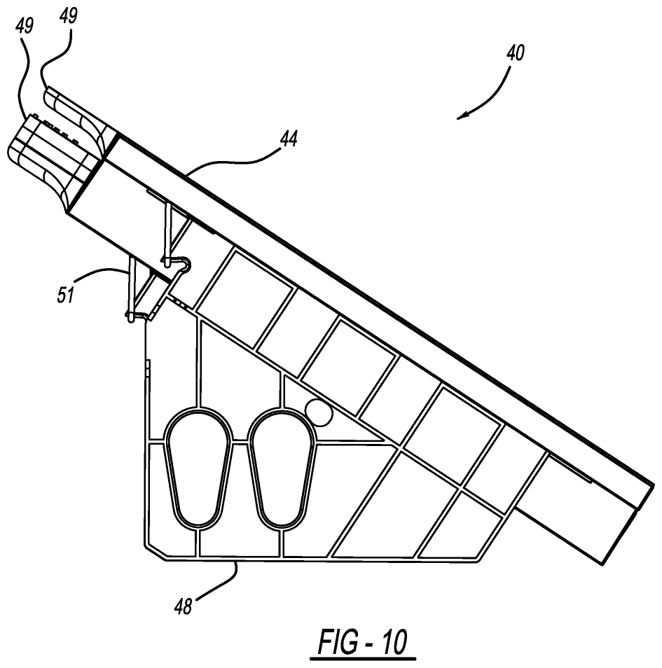

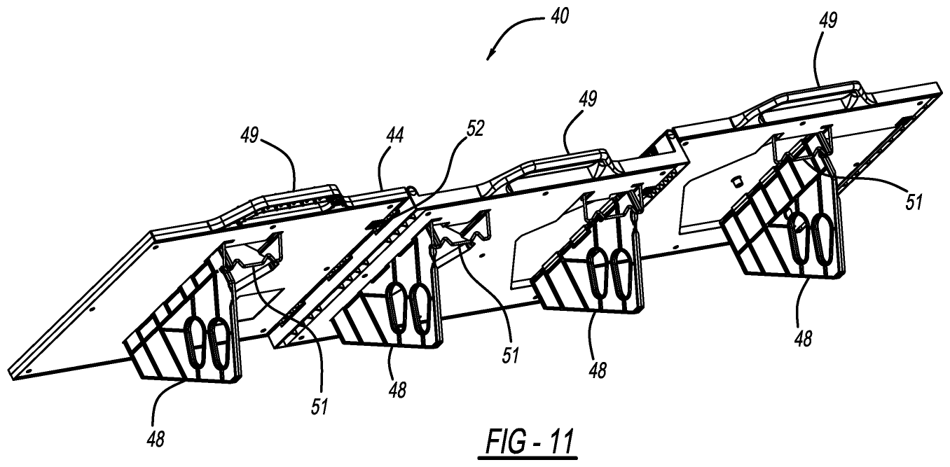

FIG. 9 shows a solar collector from the side when folded but with support structure positioned. Collector 40 includes support 48 with spring 51 and case 44. FIG. 10 is a similar view as seen from the other side of the collector. FIG. 11 shows as similar collector 40 in perspective view as seen from the rear and includes connection port 52, case 44, handles 49, spring 51.

1. A solar collector, comprising:
a case;
at least two solar panels;
at least two support structures;
at least one output port
wherein said solar collector may be reversibly rearranged
to expose said at least two solar panels to light.

2. The solar collector of claim 1 wherein said solar collector has three solar panels.

3. The solar collector of claim 1 wherein said solar collector has three support structures.

4. The solar collector of claim 1 wherein said case is formed from a hard plastic.

5. The solar collector of claim 1 wherein said case is made of acrylonitrile styrene acrylate.

6. The solar collector of claim 1 wherein said solar collector is about 4 to about 15 pounds in weight.

7. The solar collector of claim 1 wherein said solar collector is about 10.5 to 12 pounds in weight.

8. The solar collector of claim 1 wherein said support structures position said solar panels to optimize exposure to light.

9. The solar collector of claim 1 wherein solar collector has an output rating of from about 10 W to about 80 W.

10. The solar collector of claim 1 wherein said solar panels are connected in parallel.

11. The solar collector of claim 1 wherein said solar panels are connected in series.

12. The solar collector of claim 1 wherein said solar panels are connected in both series or in parallel.
